(19) United States
(12) Patent Application Publication
(10) Pub. No.: US 2021/0250746 A1
(43) Pub. Date: Aug. 12, 2021

(54) ROUTING AN EMERGENCY SERVICES CALL

(71) Applicant: NG911 Services, Inc, Bellevue, WA (US)

(72) Inventor: Donald Le Roy Mitchell, JR., Bellevue, WA (US)

(21) Appl. No.: 17/172,386

(22) Filed: Feb. 10, 2021

Related U.S. Application Data
(60) Provisional application No. 62/975,155, filed on Feb. 11, 2020.

(51) Int. Cl. H04W 4/90; H04W 4/021; G06F 16/29; H04M 3/51; H04W 64/00

(52) U.S. Cl. CPC H04W 4/90; H04W 4/021; H04W 64/003; H04M 3/5116; G06F 16/29

(57) ABSTRACT

A geospatial shape generator receives cell sector data for each of a plurality of cell sectors, wherein the cell sector data characterizes geocoordinates of a cell tower of each of the plurality of cell sectors, a radius of communication of each cell sector and a beam width of each cell sector. The geospatial shape generator can generate a geospatial shape for each of the plurality of cell sectors. The geospatial shape server can also include a boundary coordinator that queries a Geographic Information System (GIS) for geographic coordinates for each public interest structure within boundaries of each respective geospatial shape. The boundary coordinator can also determine an emergency region for each public interest structure of a plurality of public interest structures identified by the GIS. The geospatial shape server can include a call route control that provides a list of the plurality of public interest structures.

### CROSS-REFERENCE TO RELATED APPLICATION

This application claims the benefit of priority to U.S. Provisional Application No. 62/975,155, filed on 11 Feb. 2020 the entirety of which is herein incorporated by reference.

### TECHNICAL FIELD

This disclosure relates to emergency services calls, and more particularly, to routing emergency services calls.

### BACKGROUND

“9-1-1” (or “911”) is an emergency telephone number for the North American Numbering Plan (NANP), one of eight N11 codes. In North American jurisdictions, special privacy legislation permits emergency operators to obtain a 9-1-1 caller's telephone number and location information. For wireline telephones, this information is gathered by mapping the calling phone number to an address in a database. This database function is known as location data source. The database is generally maintained by the local telephone company, under a contract with a Public Service Answering Point (PSAP).

A PSAP is a call center responsible for answering calls to an emergency telephone number for police, firefighting and ambulance services. Trained telephone operators may also be responsible for dispatching these emergency services. Most PSAPs are capable of caller location for landline calls, and many can handle mobile phone locations as well (sometimes referred to as phase II location), where the mobile phone company has a handset location system.

### SUMMARY

One example relates to a geospatial shape generator that receives cell sector data for each of a plurality of cell sectors, wherein the cell sector data characterizes geocoordinates of a cell tower of each of the plurality of cell sectors, a radius of communication of each cell sector and a beam width of each cell sector. The geospatial shape generator can also generate a geospatial shape for each of the plurality of cell sectors. The geospatial shape for each respective cell sector characterizes geographical boundaries of a corresponding cell sector partition. The geospatial shape server can also include a boundary coordinator that queries a Geographic Information System (GIS) for geographic coordinates for each public interest structure within boundaries of each respective geospatial shape. The boundary coordinator can also determine an emergency region for each public interest structure of a plurality of public interest structures identified by the GIS. The geospatial shape server can further include a call route control that provides a list of the plurality of public interest structures and receives a request to associate a given public interest structure of the list of public interest structures with an emergency incident. The call route control can provide, in response to the request, a GIS reference characterizing a boundary of an emergency region that includes the given public interest structure to a network node of a public safety network that determines destination routing for emergency calls within the emergency region.

Another example relates to a non-transitory machine readable medium storing machine executable instructions. The machine executable instructions can include a geospatial shape generator that receives cell sector data for each of a plurality of cell sectors, wherein the cell sector data characterizes geocoordinates of each corresponding cell sector, a radius of communication of each cell sector and a beam width for each cell sector. The geospatial shape generator can generate a geospatial shape for each of the plurality of cell sectors, wherein the geospatial shape for each respective cell tower characterizes geographical boundaries of a corresponding cell sector partition. The geospatial shape server can also include a boundary coordinator that queries a GIS for geographic coordinates for each public interest structure within boundaries of each respective geospatial shape. The boundary coordinator can also determine an emergency region for each public interest structure of a plurality of public interest structures identified by the GIS. The geospatial shape server can further include a call route control that provides a list of the plurality of public interest structures and receives a request to associate a given public interest structure of the list of public interest structures with an emergency incident. The call route control provides, in response to the request, a GIS reference characterizing a boundary of an emergency region that includes the given public interest structure to a network node of a public safety network that determines destination routing for emergency calls within the emergency region.

Still another example relates to a method that includes receiving cell sector data for each of a plurality of cell sector. The cell sector data characterizes geocoordinates of a cell tower for each of the plurality of cell sectors, a radius of communication of each cell sector and a beam width of each cell sector. The method can also include generating a geospatial shape for each of the plurality of cell sectors. The geospatial shape for each respective cell sector characterizes geographical boundaries of a corresponding cell sector partition. The method can also include querying a GIS for geographic coordinates for each public interest structure within boundaries of each respective geospatial shape and determining an emergency region for each public interest structure of a plurality of public interest structures identified by the GIS. The method further includes receiving a request to associate a given public interest structure of a list of public interest structures with an emergency incident and providing, in response to the request, a GIS reference characterizing a boundary of an emergency region that includes the given public interest structure to a network node of a public safety network that determines destination routing for emergency calls within the emergency region.

### BRIEF DESCRIPTION OF THE DRAWINGS

FIG. 1 illustrates an example of a system configured to route emergency services calls.

FIG. 2 illustrates an example of a geospatial shape.

FIG. 3 illustrates an example of a geospatial shape that includes a public interest structure.

FIG. 4 illustrates an example of a three-dimensional geospatial shape that includes a public interest structure.

FIG. 5 illustrates an example of a region that includes a plurality of geospatial shapes that have a common public interest structure.

FIG. 6 illustrates an example of a plurality of geospatial shapes with a highway.

FIG. 7 illustrates a region that includes locations for multiple emergency services calls.

FIG. 8 illustrates a timing diagram of a system for routing an emergency services call.

FIG. 9 illustrates a flowchart of an example method for routing an emergency services call.

### DETAILED DESCRIPTION

Systems and methods are disclosed for routing emergency services calls. More particularly, the systems and methods described herein employ a geospatial shape server to assist with routing emergency services calls for a multiparty emergency incident (e.g., an emergency involving more than one party). The geospatial shape server can receive cell sector data characterizing geocoordinates for each of a plurality of cell sectors. The cell sector data of each cell sector identifies a location of a corresponding cell tower. The cell tower can include an antenna (or multiple antennas) for a telecommunication system. Moreover, different cell towers may be provided by different telecommunication systems (e.g., different telecommunications providers). The cell sector data can be provided from an agency. In some examples, the cell sector data can be a text file, such as a comma separated value (CSV) file, a spread sheet, a JavaScript Object Notation (JSON) file, or other document. The cell sector data characterizes geocoordinates (e.g., latitude and longitude) of each corresponding cell tower, a radius of communication of each cell sector and a beam width of each cell sector. The geospatial shape server can generate a geospatial shape for each of the plurality of cell sectors. The geospatial shape for each respective cell sector characterizes geographical boundaries of a corresponding cell sector partition, such as a cell sector wedge or other shape. Because the cell sectors may be provided from different telecommunication systems, some of the geospatial shapes can overlap.

The geospatial shape server can query a Geographical Information System (GIS) for geographic coordinates for each public interest structure within boundaries of each respective geospatial shape. Each public interest structure can be a place where a multiparty emergency incident is likely to occur. Accordingly, each public interest structure can be, for example, a highway, a building, a park, a hospital, an educational facilitate (e.g., a primary education facility or a University), etc. The geospatial shape server can determine an emergency region for each public interest structure of a plurality of public interest structures identified by the GIS. The emergency region can be, for example, one or more geospatial shapes or a union of a plurality of geospatial shapes. The emergency region of each public interest structure can be stored in a database (e.g., a relational database). These operations can be preprocessed in order for the geospatial server to generate a list of the plurality of public interest structures.

The geospatial server can provide a client portal, (e.g., a call control module) such as a web interface or a portal for a dedicated client. A client (e.g., a web browser or a dedicated client) can access the client portal to provide a graphical user interface (GUI) that allows selection of one of the public interest structures in the list of public interest structures. A user at the PSAP (e.g., a PSAP supervisor) can select a public interest structure. In this manner, the client can be employed to request that the geospatial server route calls for a selected public interest structure of the list of public interest structures to a given emergency call handling system. The given emergency call handling system can be, for example, a particular PSAP of a plurality of PSAPs or a specific PSAP answering group within a particular PSAP. In response to the request, the geospatial shape server can provide a GIS reference for use by network elements that determine destination routing for calls within an emergency region of the given public interest structure to the given emergency handling system. The GIS reference can be provided, for example, to an emergency call routing function (ECRF) of a public safety network to route emergency calls within an emergency region of the given public interest structure to the given emergency handling system. In other examples, the GIS reference can be provided to another or additional nodes (e.g., a LoST server) of the public safety network that can determine a network routing identifier based on the GIS reference. The GIS reference can include data characterizing a boundary (e.g., latitude and longitude coordinates) associated with the public interest structure. In response to the GIS reference, the ECRF can provide a uniform resource locator (URI) for the given emergency call handling system for some (or all) emergency calls within the emergency region of the selected public interest structure. In some examples, the GIS reference can include the URI of the given emergency call handling system. In other examples, the ECRF can determine the URI for the given emergency call handling system.

By employing the systems and methods described herein, during a multiparty emergency incident (e.g., a multivehicle accident, a school shooting, a terrorist attack, etc.) at the selected public interest structure calls that are likely related to the multiparty emergency incident can be routed to a specific PSAP or a specific answering group within a specific PSAP. This routing reduces the chances that such calls would be routed to the wrong PSAP, thereby curtailing the number of call transfers needed.

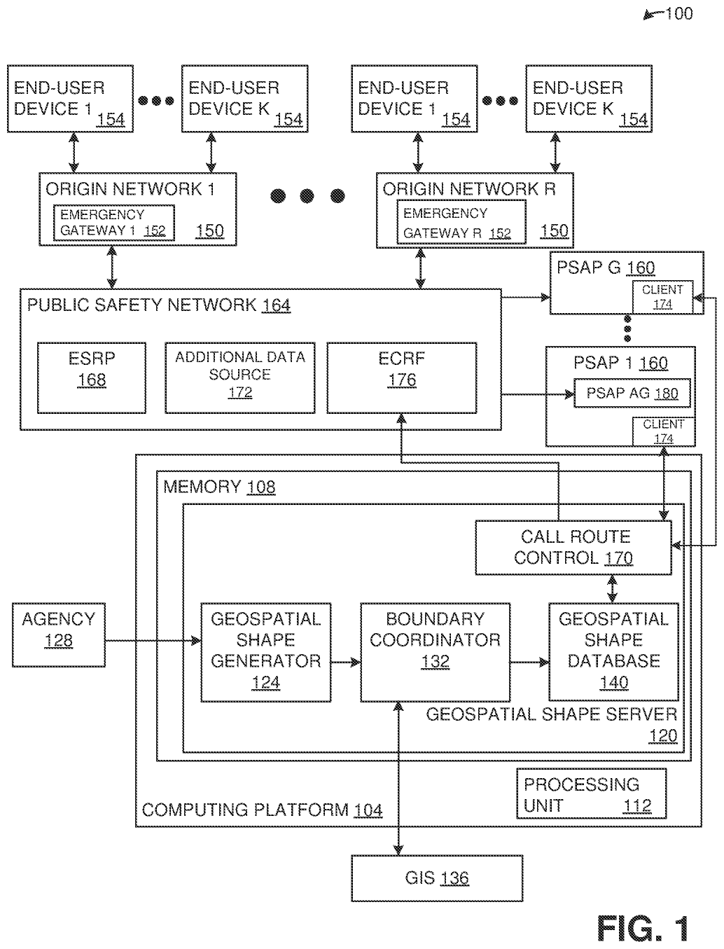

FIG. 1 illustrates an example of a system 100 configured to facilitate the processing of emergency services calls. Communication between nodes of the system 100 can be conducted via a private network (e.g., a wireless carrier network), a public network (e.g., the Internet), or a combination thereof.

The system 100 can include a computing platform 104. Accordingly, the computing platform 104 can include a memory 108 for storing machined readable instructions and data and a processing unit 112 for accessing the memory 108 and executing the machine-readable instructions. The memory 108 represents a non-transitory machine-readable memory (or other medium), such as random access memory (RAM), a solid state drive, a hard disk drive or a combination thereof. The processing unit 112 can be implemented as one or more processor cores. The computing platform 104 can include a network interface (not shown), such as a network interface card configured to communicate with other nodes of the system 100.

The computing platform 104 could be implemented in a computing cloud. In such a situation, features of the computing platform 104, such as the processing unit 112, the network interface, and the memory 108 could be representative of a single instance of hardware or multiple instances of hardware with applications executing across the multiple of instances (i.e., distributed) of hardware (e.g., computers, routers, memory, processors, or a combination thereof). Alternatively, the computing platform 104 could be implemented on a single dedicated server or workstation. Furthermore, in some examples the computing platform 104 can be employed to implement other nodes of the system 100 in a similar manner. However, for purposes of simplification of explanation, only the details of the computing platform 104 are illustrated.

The memory 108 can include a geospatial shape server 120. The geospatial shape server 120 can be configured/programmed to determine geospatial shapes for cell sectors and assist in the routing of emergency calls based on the determined geospatial shapes. The geospatial shape server 120 can include modules that execute specific operations to assist with these tasks. More particularly, the geospatial shape server can include a geospatial shape generator 124. The geospatial shape generator 124 can generate geospatial shapes that characterize geographic boundaries of a coverage area of cell sectors (e.g., a cellular base station or cell site antenna). As noted, each cell sector includes a cell tower that represents a cellular network point of ingress and egress.

In some examples, the geospatial shape generator 124 can receive cell sector data for a plurality of cell sectors from an agency 128, such as a safety agency. The agency 128 can be representative of a network node. In other examples, a different entity (or multiple entities) can provide the cell sector data. The cell sector data can be, for example raw data or formatted data representing characteristics of a radiation pattern for cell towers in each of a plurality of cell sectors in a geographic region (e.g., a political boundary). For example, the raw data can include geographic coordinates (e.g., latitude and longitude coordinates), a radius, and a beam width for each cell sector. As one example, the cell sector data can be provided, for example as a spreadsheet, such as a comma separate value (CSV) file, a spread sheet, a JSON file, or other document.

Each cell sector can be associated with a particular telecommunications carrier. Each cell sector can be, for example a second generation (2G) cell sector, a third generation (3G) cell sector, a Long Term Evolution (LTE) cell sector, a fifth generation (5G) cell sector, etc. Moreover, the cell sector data can include data for cell towers of different telecommunications carriers. In such a situation, the area covered by different cell sectors can overlap.

The geospatial shape generator 124 can employ the cell sector data to calculate a geospatial shape for each cell sector of the plurality of cell sectors. Each such geospatial shape can be represented by geographic boundaries defined in latitude and longitude coordinates. Each such geospatial shape can represent, for example an antenna coverage area, a cell site sector partition, such as a cell sector wedge, or a shape similar to a cell site sector wedge. The region within each geospatial shape can be associated with a particular Public Safety Answering Point (PSAP). Accordingly, emergency calls originating from the region within each geospatial shape are routed to a respective PSAP.

The examples provided relate to cellular telecommunication networks. However, this is just one example. The system 100 is adaptable for any RF communication protocol, such as Wi-Fi, Bluetooth, etc. In any such situation, the geospatial shape server 120 can be provided information from the agency 128 characterizing a location of a wireless access point (WAP) or multiple WAPs. The WAP can be, for example, a Wi-Fi router, or a Bluetooth access point. In this situation, the geospatial shape generator 124 can be configured/programmed to generate geographic boundaries for a shape (e.g., a wedge, a circle, etc.) that represents an antenna coverage area defined in latitude and longitude coordinates for each such WAP. The coverage areas for each WAP have properties similar to a cell sector, such as beam width, radius, etc. Accordingly for purposes of simplification of explanation, such coverage areas (and/or a partition of a coverage area) for each of a plurality of WAPs can also colloquially be referred to as a cell sector (and/or a cell sector partition, such as a cell sector wedge).

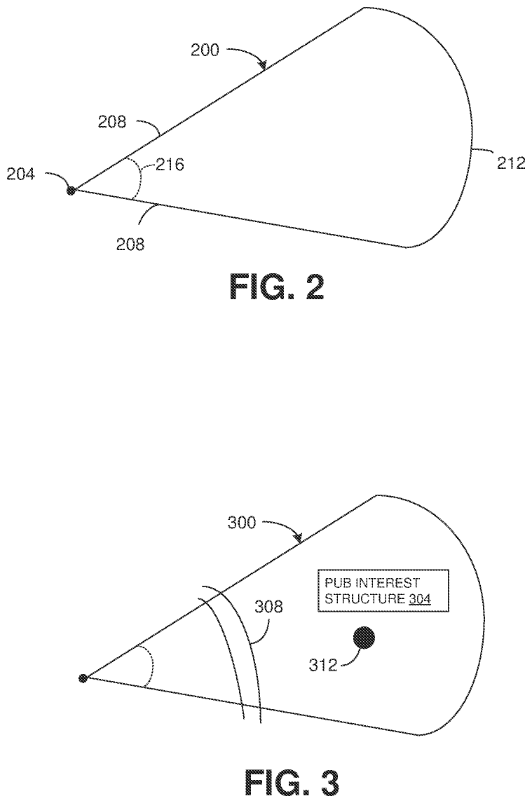

FIG. 2 illustrates a diagram of a geospatial shape 200 for a particular cell sector. The geospatial shape 200 includes a point 204 that represents a location of a cell tower of the cell sector. In the example illustrated, the geospatial shape 200 is a wedge or cone shape, but in other examples, other shapes are possible. Moreover, in the example illustrated, the geospatial shape 200 represents a two-dimensional (2D) shape, but in other examples, the geospatial shape can be implemented as a three-dimensional (3D) shape. Each edge 208 has a length about equal to the radius defined in the cell sector data. Moreover, a base 212 of the geospatial shape 200 is based on the beam width 216 of the cell sector (defined in degrees or radians) and the cell tower positioned at the point 204. The boundaries of the geospatial shape 200 can be defined in latitude and longitude coordinates.

Referring back to FIG. 1, the geospatial shape generator 124 can provide each calculated geospatial shape to a boundary coordinator 132 of the geospatial shape server 120. In response to receipt of each geospatial shape, the boundary coordinator 132 can query a geographic information system (GIS) 136 for public interest structures that are within a respective geospatial shape. More particularly, the boundary coordinator 132 can generate the query using an application programming interface (API) call to the GIS 136. The query for each geospatial shape can include the geographic boundaries of the respective geospatial shape. Moreover, in some examples, the boundary coordinator 132 can provide multiple queries to the GIS 136, such as one query per type of public interest structure.

The public interest structure can be, for example, a structure in which an multiparty emergency incident is likely to occur. For instance, the public interest structure could be a building, and education facility (e.g., primary education facility, such as an elementary school or a high school or secondary education, such as a college or university), a hospital, a public park, a highway, etc. This list is not meant to be exhaustive. In other examples, other structures might be considered a public interest structure. The multiparty emergency incident could be, for example a life-threatening event, such as a terrorist attack, a building shooting (e.g., a school shooting), a multi-vehicle accident, etc.

In response to the query, the GIS 136 can return boundaries of the public interest structure to the boundary coordinator 132. Additionally, in some examples, the GIS 136 can include a point (e.g., latitude and longitude coordinates) associated with the public interest structure. The boundary coordinator 132 can store the geospatial shape, along with the shape of the public interest structure and the associated point in a geospatial shape database 140. FIG. 3 illustrates an example of a geospatial shape 300 that includes a public interest structure 304 and a highway 308 within the boundaries of the geospatial shape 300. In the example illustrated, it is presumed that the boundaries of the public interest structure 304 and the highway 308 are returned in response to a query from a GIS (e.g., the GIS 136 of FIG. 1). Additionally, the geospatial shape 300 includes a point 312 associated with the public interest structure 304. For purposes of simplification of explanation, the geospatial shape 300 has the same shape as the geospatial shape 200 of FIG. 2.

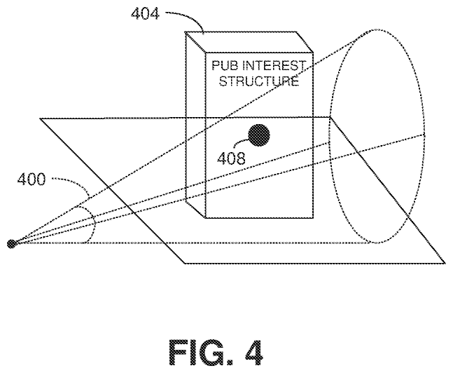

FIG. 4 illustrates an example of a geospatial shape 400 that includes a public interest structure 404 within the boundaries of the geospatial shape 400. In the example illustrated, it is presumed that the boundaries of the public interest structure 404 is returned in response to a query from a GIS (e.g., the GIS 136 of FIG. 1). The geospatial shape 400 is a 3D shape (a cone). In the example illustrated, a portion of the public interest structure 404 is enveloped by the geospatial shape 400. As noted, the geospatial shape 400 represents a region serviced by a particular PSAP. Thus, in the example illustrated, it is presumed that different portions of the public interest structure 404 (e.g., different floors) are serviced by different PSAPs, or call groups within a given PSAP or a call group distributed over multiple PSAPs. In other examples, the same PSAP can service the entirety of the public interest structure 404. A point 408 associated with the public interest structure that is within the boundaries of the geospatial shape 400 is also included.

Referring back to FIG. 1, the geospatial shape database 140 can be implemented, for example as a relational database, such as a search and query language (SQL) database. Moreover, although the geospatial shape database 140 is illustrated as being stored locally in the memory 108, in other examples, the geospatial shape database 140 can be stored on external system and accessed by the geospatial shape server 120 remotely. The geospatial shape database 140 can store records for each geospatial shape generated for each cell sector identified in the cell sector data. Each such record can include, for example the boundaries of a respective geospatial shape, the boundaries of the public interest structure within the boundaries of the respective geospatial shape and a location (latitude and longitudinal coordinates) associated with the public interest structure.

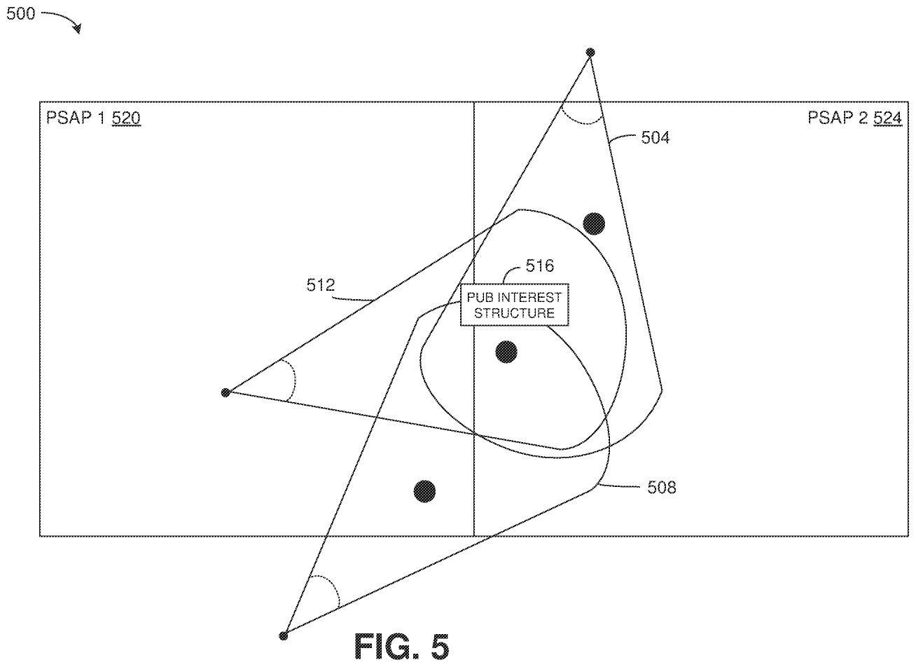

The boundary coordinator 132 can preprocess the records in the geospatial shape database 140 to assign each public interest structure to one geospatial shape that may be defined by the boundaries of multiple geospatial shapes generated by the geospatial shape generator 124. FIG. 5 illustrates a diagram representing a geographic region 500 where three different geospatial shapes, namely a first geospatial shape 504, a second geospatial shape 508 and a third geospatial shape 512 each contain the same public interest structure 516.

The first geospatial shape 504, the second geospatial shape 508 and the third geospatial shape 512 could each be representative of cell sector partitions (cell sector wedges) for different telecommunications providers. Furthermore, the geographic region 500 includes two regions, labeled PSAP 1 520 and PSAP 2 524. In normal conditions, emergency calls originating within the region defined by the PSAP 1 520 are routed to the PSAP 1, and emergency calls originating within the region defined by the PSAP 2 524 are routed to PSAP 2. However, in certain circumstances, such as a multiparty emergency incident, some (or all) emergency services calls originating within any of the first geospatial shape 504, the second geospatial shape 508 or the third geospatial shape 512 should be routed to an emergency handling system such as a particular PSAP, and more specifically, to an answer group within the particular PSAP. Referring back to FIG. 1, the boundary coordinator 132 of FIG. 1, can associate a public interest structure, such as the public interest structure 516 of FIG. 5 with a union of geospatial shapes such as each of the first geospatial shape 504, the second geospatial shape 508 and the third geospatial shape 512 and store the relationship in the geospatial shape database 140 of FIG. 1. Accordingly, the preprocessing executed by the boundary coordinator 132 can assign one or more geospatial shapes (or a union of geospatial shapes) to each public interest structure retrieved from the GIS 136, which region can be referred to as an emergency region for the public interest structure. That is, during the preprocessing, the boundary coordinator 132 can assign each public interest structure received from the GIS an emergency region, and this relationship can be stored in the geospatial shape database.

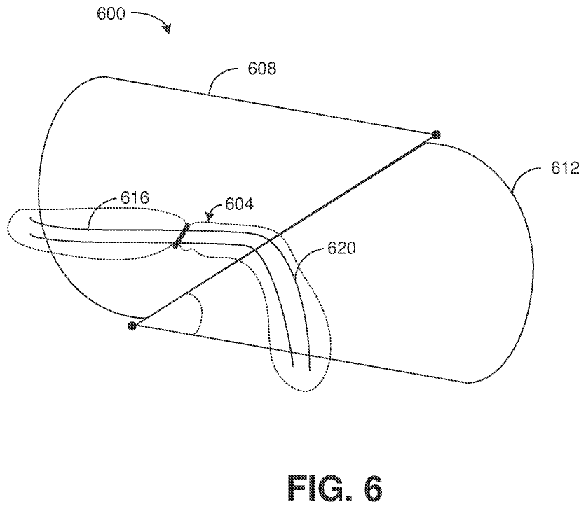

FIG. 6 illustrates an example of a geographic region 600 where the public interest structure is a highway 604 that crosses into two different geospatial shapes, namely a first geospatial shape 608 and a second geospatial shape 612. Moreover, the highway 604 includes a first segment 616 and a second segment 620. In the example illustrated in FIG. 6, the boundary coordinator 132 of FIG. 1 can assign a shape of the first segment to the first geospatial shape 608 and assign the second segment 620 to the second geospatial shape 612 and record the assignment in the geospatial shape database 140.

Referring back to FIG. 1, the system 100 can include R number of origin networks 150 that each communicate with K number of end-user devices 154, where R and K are each integers greater than or equal to one. Moreover, different origin networks 150 can have a different number (or the same number) of end-user devices 154.

Each origin network 150 can be representative of a telecommunications network, such as a wireless communications network. Each end-user device 154 is operated by an end-user, which end-user can be referred to as a caller. The end-user device 154 can be a mobile device, such as a wireless phone operating on a carrier network (e.g., a smart phone, a feature phone, etc.), a Voice over Internet Protocol (VoIP) phone, etc. As an alternative, each end-user device can be referred to as user equipment (UE). Each of the R number of origin networks 150 can include an emergency gateway 152 to route emergency calls from respective end-user devices 154. Each emergency gateway 152 (or some subset thereof) can be configured as a router (e.g., a hardware device). In some examples, each emergency gateway 152 (or some subset thereof) can be implemented as a distributed computing device (e.g., an instance of virtual hardware) executing in a computing cloud. In other examples, each emergency gateway 152 (or some subset thereof) can be implemented as a single instance of hardware.

Each emergency gateway 152 can include the functionality and/or structure of a positioning center. The positioning center of each respective emergency gateway 152 can be representative of nearly any non-landline positioning center, including a Mobile Positioning Center (MPC), a Gateway Mobile Positioning Center (GMLC), location retrieval function (LRF) and/or an emergency routing services (ERS) node, a VoIP Positioning Center (VPC), etc. The nodes of the system 100 (including the emergency gateway 152) can communicate with standard protocols, such as the HTTP (Hypertext Transfer Protocol)-Enabled Location Deliver Protocol (HELD) and/or the Mobile Location Protocol (MLP).

Each end-user device 154 can be employed by the respective caller to initiate an emergency services call. The emergency services call can be, for example, a voice 9-1-1 call, a 9-1-1 text (or short) message (e.g., a short message service (SMS) message or a real-time text (RTT) message), etc. The emergency services call can be a request for immediate emergency assistance, including ambulatory service, police assistance, fire department assistance, assistance on waterways or some combination thereof. In some examples, the end-user device 154 may be issued or controlled by a particular enterprise (e.g., a business) that maintains its own call center (e.g., a secondary call center) for handling emergency services calls.

Each emergency services call can be routed to a particular PSAP 160 of G number of PSAPs 160 via a public safety network 164 in a manner described herein, where G is an integer greater than one. In particular, each end-user device 154 can be connected to a node of a respective origin network 150, such as a primary service delivery node (PSDN). In examples where a particular end-user device 154 is a mobile phone operating on a carrier network, a respective origin network 150 can include a Mobile Switching Center (MSC). In examples where the end-user device 154 is a VoIP phone, the respective origin network can include a VoIP service provider (VSP). The respective origin network 150 can be connected to the public safety network 164. The public safety network can be representative of a collection of telephony routers, including, but not limited to a cell tower, selective routers, etc. The public safety network 164 can also include routing and location nodes, such as an emergency services routing proxy (ESRP) 168, an additional data source 172 and an emergency service routing function (ESRF) 176. The public safety network 164 can be implemented as part of the Public Switched Telephone Network (PSTN), the Internet and/or as part of a private network (e.g., a wireless carrier network).

To illustrate operation of the system 100, an extended example is provided (hereinafter, “the given example”). In the given example, a given end-user device 154 is employed to make a given emergency services call form a given end-user device 154 connected to a given origin network 150 (e.g., end-user device 1 of origin network 1). In response, the given origin network 150 can provide a notification of the emergency services call to a given emergency gateway 152 of the given origin network 150. In some examples, signaling for the given emergency services call can include device-based location information (e.g., geographic coordinates, such as latitude and longitude coordinates). The device-based location information can be determined by the given end-user device 154 (e.g., with a global positioning system (GPS)) or in concert with the origin network 150 (e.g., through triangulation). Further, in some situations, the device-based location information can include an altitude. In other examples, the device-based location information can be omitted.

In response to the notification of the emergency services call, the given emergency gateway 152 can be configured to query the ESRP 168 of the public safety network 164 for location information of the given emergency services call. In response, the ESRP 168 can provide the location information (e.g. a cell sector identifier) to the given emergency gateway 152, and the given emergency gateway 152 can forward signaling, such as a Session Initiation Protocol (SIP) invite for the given emergency services call to the ESRP 168.

In response to the signaling, the ESRP 168 can query the additional data source 172 of the public safety network 164 for geographical coordinates for the given end-user device 154. In response, the additional data source 172 can return location information including latitude and longitude coordinates (e.g., geographic coordinates) for the given end-user device 154. In response to receipt of the location information from the additional data source 172, the ESRP 168 can execute a policy decision for the given emergency services call. The policy can be based, for example on the presence or absence of device location information in the given emergency services call. The policy can dictate selection of location information. More particularly, the policy can dictate whether to select the location information (the latitude and longitude coordinates) provided from the additional data source 172 or to select the device-based location information (if included) to route the given emergency services call. In some examples, the policy can be based on a timestamp included with the device-based location information. Upon determining the policy decision, the ESRP 168 can query the ECRF 176 for an identity of a particular PSAP 160 or answer group 180 of the G number of PSAPs 160 to handle the given emergency services call with the selected location information. The identity of the particular PSAP 160 or the answer group 180 can be provided as a uniform resource identifier (URI). As one example, the ECRF can be a Location to Service Translation (LoST) server. In such a situation the query to the ECRF 176 can be formatted as a Location to Service Translation (LoST) query that includes the selected location information (e.g., latitude and longitude) of the given end-user device 154.

In response to the query from the ESRP 168 (e.g., the LoST query), the ECRF 176 can return a URI for a given PSAP 160 or a given PSAP answer group 180 that can handle the given emergency services call. In response, the ESRP 168 can forward the signaling for the given emergency services call to the given PSAP 160, such that the given emergency services call is connected to an operator of the PSAP 160.

Most emergency calls can be handled in a manner similar to the given emergency services call. However, in situations where a multiparty emergency incident occurs, multiple calls to the G number of PSAPs (or some subset thereof) are likely made to report the multiparty emergency incident. For instance, if a school shooting (an example of a multiparty emergency incident) occurs at a particular school, many calls from end-user devices 154 that are in or around the particular school will be made. Some of these calls are likely to be from different origin networks 150 (e.g., different telecommunication networks). Moreover, with standard operating procedures, these calls may be routed wrongly and need to be transferred, which can increase emergency response time at a detriment to public safety.

To address multiparty emergency incidents the geospatial shape server 120 can include a call route control module 170. The call route control module 170 can include, for example a client portal, such as a web portal for the geospatial shape server 120. Each of the G number of PSAPs 160 (or some subset thereof) can operate a client 174 (e.g., a web client or a dedicated client) for accessing the call route control module 170 of the geospatial shape server 120.

The call route control module 170 can access the geospatial database and provide a selectable list of public interest structures that are within geospatial shapes. As an example, the call route control module 170 can provide a list that includes the public interest structure 304 and the highway 308 of FIG. 3. The client 174 of each PSAP 160 can select a particular public interest structure from the list of public interest structures and associate the multiparty emergency incident with a particular emergency handling system, such as an answering group within the respective PSAP 160 such that further emergency calls for the multiparty emergency incident are likely to be routed to the particular emergency handling system.

As an example of operation, suppose that a PSAP operator (e.g., a supervisor) of the first PSAP 160 (PSAP 1) employs the client 174 to select a particular public interest structure (e.g., a school) to initiate a request to the call route control module 170 to route emergency services calls for the particular public interest structure in response to a report of a multiparty emergency incident. Additionally, in some examples, the request can include data identifying an emergency handling system, such as a PSAP answering group 180 (PSAP AG) or another type of emergency handling system that is designated to handle calls for the multiparty emergency incident. In other examples, the request can omit the information identifying the particular emergency handling system. In response, the call route control module 170 can query the geospatial shape database 140 for one or more geospatial shapes or a union of geospatial shapes that are associated with the selected public interest structure (e.g., the school), and designate the one or more geospatial shapes or a union of geospatial shapes as an emergency region. Moreover, the call route control module 170 can provide a GIS reference to the ECRF 176 and/or to other nodes of the public safety network 164. The GIS reference can include data that characterizes the boundaries of the emergency region. The GIS reference can be a latitude and longitude coordinate or a set of latitude and longitude coordinates. The GIS reference provided to the nodes of the public safety network 164 (e.g., the ECRF 176) cause emergency calls originating within the emergency region to be routed to the first PSAP 160 and/or the PSAP answering group 180 of the first PSAP 160. The GIS reference can include, boundaries of the emergency region in the Extensible Markup Language (XML) format or the GeoJSON (Geo JavaScript Object Notation) format or another standard format.

Accordingly, the system 100 can process emergency calls for the multiparty emergency incident in a manner similar to the given emergency call in the given example. However, during the multiparty emergency incident in contrast to the given example, in some situations where the latitude and longitude (returned by the additional data source 172) is within the boundaries of the emergency region and the signaling associated with the emergency services call does not include device-based location (e.g., latitude and longitude coordinates determined by the end-user device 154), the ECRF 176 can return a URI for an emergency handling system, namely the first PSAP 160 or the PSAP answering group 180 within the first PSAP 160. Stated differently, in response to the query from the ESRP 168 (e.g., a LoST query) that identifies latitude and longitudinal coordinates within the emergency region, the ECRF 176 can return a URI for the emergency handling system (e.g., the first PSAP 160 or the PSAP answering group 180 within the first PSAP 160). In this manner, emergency calls that are likely related to the multiparty emergency incident are efficiently transferred to the appropriate PSAP 160 and/or the appropriate PSAP answering group 180, thereby reducing a number of transfers needed to provide information and/or dispatch emergency services for the multiparty emergency incident. For instance, in the example illustrated in FIG. 5, if the public interest structure 516 is selected, some or all emergency calls within a region defined by the union of the first geospatial shape 504, the second geospatial shape 508 or the third geospatial shape 512 are routed to the PSAP 1 160 or the PSAP answering group 180 of the PSAP 1 160.

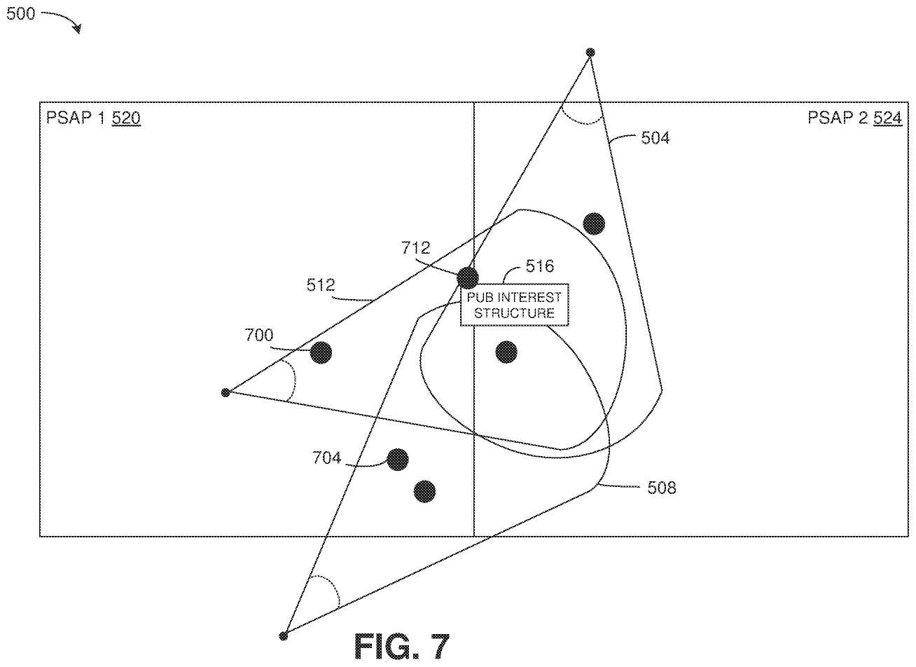

To illustrate the call routing during a multiparty emergency incident, FIG. 7 illustrates the geographic region 600 of FIG. 6 that includes a first location 700 of a first emergency call, a second location 704 of a second emergency services call and a third location 712 of a third emergency services call. In this example, it is presumed that signaling for the first emergency services call at the first location 700 includes device-based location information (e.g., latitude and longitude determined by an end-user device). Additionally it is presumed that the signaling for the second emergency services call at the second location 704 omits device-based location information. Furthermore, it is presumed that the URI for PSAP 1 520 is wtpgroup@us.state.agency.psap1 and the URI for PASP 2 is wtpgroup@us.state.agency.psap2. In this situation, upon selecting the public interest structure 516 for a multiparty emergency incident, an ECRF (e.g., the ECRF 176 of FIG. 1) is provided a GIS reference to route calls such that emergency calls that omit device-based location information that originate from the region defined by the union of the first geospatial shape 504, the second geospatial shape 508 and the third geospatial shape 512 to a PSAP answering group with a URI of

callgroup2@us.state.agency.psap2. Accordingly, the second emergency services call from the second location 704 that omits the device-based location information is routed to callgroup2@us.state.agency.psap2 during the multiparty emergency incident. Conversely, in some examples (depending on a policy) the first emergency services call from the first location 700 that includes device-based location information is routed in the standard manner, such that the first emergency services call is routed to the PSAP 1 with the URI of wtpgroup@us.state.agency.psap1. In other examples, (depending on the policy) both the first emergency services call and the second emergency services call are routed to callgroup2@us.state.agency.psap2 during the multiparty emergency incident.

Further still, during the multiparty emergency incident the third emergency services call from the third location 712 is routed to the PSAP answering group with a URI of callgroup2@us.state.agency.psap2 whether or not the signaling for the third emergency services call includes device-based location information. The third emergency services call is routed in this manner because if the third emergency services call omits device-based location information, the third emergency services call is routed in the same manner as the second emergency services call during the multiparty emergency incident. Conversely, if the signaling of the third emergency services call includes device-based location information, the geographic coordinates included in such emergency services call would be within the boundaries of the public interest structure 516, as indicated by the third location 712. This indicates that the caller of the third emergency services call is physically within the public interest structure 516.

Referring back to FIG. 1, as noted, in some examples, the geospatial shape associated with a public interest structure can be 3D, such as the geospatial shape 400 illustrated in FIG. 4. In such a situation, a PSAP operator (e.g., a PSAP supervisor) can employ the client 174 to request that the call route control module 170 assign different portions of the same public interest structure to different PSAPs 160 and/or different PSAP answering groups 180 within the same or different PSAP 160. This may be beneficial in situations where different emergency services (e.g., longer ladders, helicopters, etc.) are needed to deploy emergency services to higher portions of the public interest structure than are needed for the lower portions of the same public interest structure. In this situation, the call route control module 170 can provide a particular GIS reference to nodes of the public safety network 164. The call route control provides this GIS reference to nodes of the public safety network 164 that determine destination routing. For example, the GIS reference can be provided to the ESPR 168 and/or the ECRF 176 to route calls with an altitude below a certain level to one particular PSAP 160 and/or to one particular PSAP answering group 180 and calls with an altitude above that level to another PSAP 160 and/or to another PSAP answering group 180. In this situation, altitude (also referred to as Z axis) information included with signaling of the emergency services call can be included in the query (e.g., a LoST query) to the ECRF 176. In this manner, calls for the same multiparty emergency incident can be routed to different PSAPs 160 and/or different PSAP answering groups 180.

At some point in the future, the multiparty emergency incident concludes. In this situation, the PSAP operator (e.g., the supervisor) can employ the client 174 to notify the call route control module 170 that the multiparty emergency incident has concluded. In response, the call route control module 170 can send a request to the ECRF 176 (and/or additional nodes of the public safety network 164) to terminate the special routing of the emergency services calls, such that future emergency services calls are handled in a manner similar to the given example.

By employing the system 100 of FIG. 1, during a multiparty emergency incident, calls that are likely to be related to the multiparty emergency incident can be routed to a particular PSAP answering group 180. This PSAP answering group 180 is likely to be privity to information related to the multiparty emergency incident, and can avoid unneeded rerouting of calls.

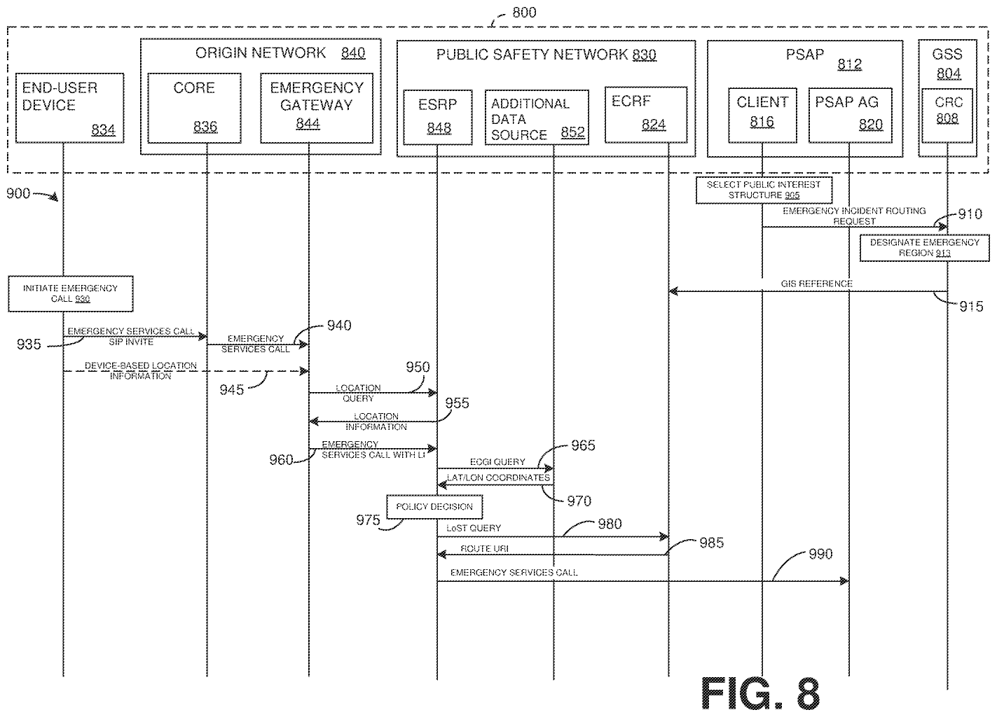

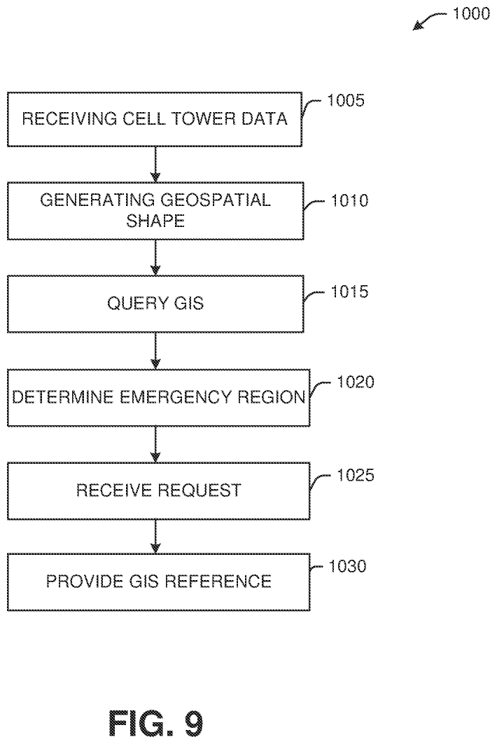

FIG. 8 illustrates a timing diagram for a system 800 for executing a method 900 to route emergency services calls related to a multiparty emergency incident. The system 800 can include nodes that communicate over a public network, such as the Internet, a private network, such as a wireless carrier network or a combination thereof.

The system 800 can include a geospatial shape server 804 (labeled GSS), such as the geospatial shape server 120 of FIG. 1. In the method 900, it is presumed that the geospatial shape server 804 has preprocessed a geospatial shape database (e.g., the geospatial shape database 140 of FIG. 1) to associate each of a plurality of selectable public interest structures with one or more geospatial shapes or a union thereof. Additionally, it is presumed that in the method 900, a multiparty emergency incident has been reported for a particular public interest structure.

The system 800 includes a call route control module 808 (labeled CRC) that is configured/programmed to provide a client portal (e.g., a web portal or a dedicated client portal) for the geospatial shape server 804. The system 800 also includes a PSAP 812 that represents an instance of a PSAP 160 of FIG. 1. The PSAP 812 can include a client (e.g., a web client or a dedicated client) for accessing the call route control module 808. The client 816 can be employed to implement an instance of the client 174 of FIG. 1. At 905, the client 816 is employed to select the particular public interest structure from a list of public interest structures provided by the call route control module 808 and (in some examples) to provide information identifying a particular emergency handling system, such as the PSAP answering group 820 to handle the multiparty emergency incident. At 910, the client 816 is employed to provide an emergency incident routing request of the particular public interest structure. In some examples, the emergency incident routing request identifies the PSAP answering group 820 and the particular public interest structure. In other examples, the information identifying the PSAP answering group 820 is omitted.

In response, at 913, the call route control module designates an emergency region for the public interest structure (identified in a geospatial database). The emergency region can be one or more geospatial shapes or a union thereof. At 915, the call route control module 808 provides a GIS reference for the emergency incident to an ECRF 824 of a public safety network 830. In other examples, the GIS reference can be provided to additional or alternative nodes of the public safety network 830. The public safety network 830 can be employed to implement the public safety network 164 of FIG. 1, and the ECRF 824 can be employed to implement the ECRF 176 of FIG. 1. The GIS reference can include a boundary of an emergency region (an area) that includes the public interest structure, such that emergency calls originating within. In some examples, the emergency region can be provided in XML or geoJSON format to the ECRF 824. Moreover, in some examples, the GIS reference (and/or other messaging) can include a URI of the emergency handling system, namely the PSAP answering group 820. In other examples, this information pertaining to the URI of the emergency handling system can be omitted.

The system 800 can include an end-user device 834. The end-user device 834 can be implemented, for example, as a VoIP phone (mobile or fixed-based), a wireless phone (e.g., a smart phone or feature phone operating on a carrier network), etc. The end-user device 834 can be employed to implement an instance of the end-user device 154 illustrated in FIG. 1. The emergency services call can be, for example, a voice 9-1-1 call, a 9-1-1 text (or short) message (e.g., a short message service (SMS) message or a multimedia service (MMS) message), etc.

At 930, the end-user device 834 can be employed to initiate an emergency services call (e.g., a 9-1-1 voice or text call in North America). A user of the end-user device 834 can be referred to as a caller (of the emergency services call). At 935, the emergency services call can be implemented as signaling for a SIP invite that is provided to a core 836 of an origin network 840 (e.g., at a primary service delivery node), which can be implemented as an MSC on a wireless subscriber network that communicates with the end-user device 834 or a VSP that communicates with the end-user device 834 on a TCP/IP network. The core 836 can detect that the call is an emergency services call (e.g., by detecting that the call is directed to an emergency services contact center if the call has “9-1-1” digits). At 940, the core 836 can process the emergency services call and route/forward the emergency services call to an emergency gateway 844 of the origin network 840. The emergency gateway 844 can be implemented with the emergency gateway 152 of FIG. 1 and can be representative of telephony network components and/or Internet network components needed to route or provide routing information to connect the emergency services call to an appropriate call handling facility (e.g., a PSAP). Additionally, in some examples, at 945, the end-user device 834 provides the emergency gateway 844 with device-based location information (e.g., latitude and longitude coordinates). In other examples, the operation at 945 are omitted.

At 950, the emergency gateway 844 queriers an ESRP 848 (e.g., the ESRP 168 of FIG. 1) for location information based on the signaling (e.g., a SIP invite) of the emergency services call. At 955, the ESRP 848 retrieves location information (e.g., a cell sector ID) for the end-user device 834, and provides the retrieved information to the emergency gateway 844.

At 960, the emergency gateway forwards the emergency services call, along with the signaling (SIP invite) to the ESRP 848. At 965, the ESRP 848 executes an E-UTRAN cell global identifier (ECGI) query to an additional data source 852 (e.g., the additional data source 172 of FIG. 1) based on the cell sector ID provided from the ESRP 848. In response, at 970 the additional data source 852 provides location information including latitude and longitude coordinates for the end-user device 834. In the example illustrated, it is presumed that the latitude and longitude coordinates returned by the additional data source 852 are within the emergency region for the public interest structure designated by the geospatial shape server 804.

At 975, the ESRP makes a policy decision as to whether to select the location information provided from the additional data source 852 to route the emergency services call or to select the device-based location information that may or may not be provided at 945 for routing the emergency services call. In examples where the device-based location is provided, the ESRP 848 may select the location information provided from the additional data source 852 if the device-based location information is stale (e.g., the device-based location information has not been updated within a configurable time threshold). In examples where the device-based location is omitted, the ESRP 848 also selects the location information provided from the additional data source 852. In still other examples, where the device-based location information is included and has been updated more recently than the time threshold, the ESRP 848 can select the device-based location information to route the emergency services call. In the method 900, it is presumed that the ESRP selects the latitude and longitude coordinates provided from the additional data source 852.

At 980, the ESRP 848 employs the selected location information to generate a LoST query (or other routing query) that is provided to the ECRF 824. At 985, the ECRF 824 returns a URI for the PSAP answering group 820. At 990, the emergency services call and the signaling (SIP invite) are provided to the PSAP answering group 820 identified in the URI to connect the emergency services call with a PSAP operator within the PSAP answering group 820.

In view of the foregoing structural and functional features described above, example methods will be better appreciated with reference to FIG. 9. While, for purposes of simplicity of explanation, the example method of FIG. 9 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 9 can be implemented as instructions stored in a non-transitory machine-readable medium. The instructions can be accessed by a processing resource (e.g., one or more processor cores) and executed to perform the methods disclosed herein.

FIG. 9 illustrates a flowchart of an example method 1000 for routing emergency services calls for a multiparty emergency incident. The method 1000 can be implemented by a geospatial shape server, such as the geospatial shape server of FIG. 1 and/or the geospatial shape server 804 of FIG. 8. At 1005, the geospatial shape server can receive cell sector data characterizing geocoordinates, a radius (e.g., a coverage radius) and a beam width for each of a plurality of cell sectors. The cell sector data can be provided from an agency, such as the agency 128 of FIG. 1. In some examples, the cell sector data can be a text file, such as a CSV file, a spread sheet, a JavaScript Object Notation (JSON) file or other document. At 1010, the geospatial shape server can generate a geospatial shape for each of the plurality of cell sectors. The geospatial shape for each respective cell sector characterizes geographical boundaries of a corresponding cell sector partition (e.g., a cell sector wedge or other shape).

At 1015, the geospatial shape server queries a GIS (e.g., the GIS 136 of FIG. 1) for geographic coordinates for each public interest structure within boundaries of each respective geospatial shape. At 1020, the geospatial shape server can determine an emergency region for each public interest structure of a plurality of public interest structures identified by the GIS. The emergency region of each public interest structure can be stored in a database (e.g., the geospatial shape database 140 of FIG. 1).

At 1025, the geospatial shape server can receive a request to associate a given public interest structure of a list of public interest structures with an emergency incident (e.g., a multiparty emergency incident, as discussed), which request can be referred to as an emergency incident routing request. At 1030, the geospatial shape server can provide, in response to the request, a GIS reference characterizing a boundary of an emergency region that includes the given public interest structure to a network node of a public safety network that determines destination routing for emergency calls within the emergency region. For instance, the GIS reference can be provided to an ECRF and/or other nodes of the public safety network. The GIS reference can be implemented with latitude and longitude coordinates or a set of latitude and longitude coordinates.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, solid-state storage devices, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A geospatial shape server operating on a computing platform, the geospatial shape server comprising:
a geospatial shape generator that:
receives cell sector data for each of a plurality of cell sectors, wherein the cell sector data characterizes geocoordinates of a cell tower of each of the plurality of cell sectors, a radius of communication of each cell sector and a beam width of each cell sector; and
generates a geospatial shape for each of the plurality of cell sectors, wherein the geospatial shape for each respective cell sector characterizes geographical boundaries of a corresponding cell sector partition;
a boundary coordinator that:
queries a Geographic Information System (GIS) for geographic coordinates for each public interest structure within boundaries of each respective geospatial shape; and
determines an emergency region for each public interest structure of a plurality of public interest structures identified by the GIS; and
a call route control that:
provides a list of the plurality of public interest structures;
receives a request to associate a given public interest structure of the list of public interest structures with an emergency incident; and
provides, in response to the request, a GIS reference characterizing a boundary of an emergency region that includes the given public interest structure to a network node of a public safety network that determines destination routing for emergency calls within the emergency region.

2. The geospatial shape server of claim 1, wherein the request includes data identifying a particular Public Answering Safety Point (PSAP) of a plurality of PSAPs.

3. The geospatial shape server of claim 1, wherein request includes data identifying a particular answering group of a particular Public Answering Safety Point (PSAP) of a plurality of PSAPs.

4. The geospatial shape server of claim 1, wherein a given geospatial shape is a two-dimensional (2D) shape.

5. The geospatial shape server of claim 1, wherein a given geospatial shape is a three-dimensional (3D) shape.

6. The geospatial shape server of claim 5, wherein the public interest structure is a building, the geospatial shape is a first geospatial shape that covers a first portion of the building, and the geospatial shape generator:
generates a second geospatial shape that covers a second portion of the building;
receives a request to associate the second portion of the building with another PSAP of the plurality of PSAPs; and
commands, in response to the request, the ECRF to route calls within the second portion of the building to the other PSAP.

7. The geospatial shape server of claim 1, wherein the boundary coordinator stores data characterizing the emergency region of each public interest structure in a database.

8. The geospatial shape server of claim 1, wherein a given emergency region of a public interest structure of the plurality of public interest structures represents a boundary of a union of two or more geospatial shapes.

9. The geospatial shape server of claim 1, wherein the call route control provides the boundaries of the emergency region in GeoJSON format.

10. The geospatial shape server of claim 1, wherein the call route control provides data characterizing a uniform resource identifier (URI) of a particular emergency handling system for the emergency incident to the ECRF.

11. The geospatial shape server of claim 1, wherein the request is provided to the call route control in response to a multiparty emergency incident reported at the given public interest structure.

12. The geospatial shape server of claim 1, wherein the given public interest structure is a school, a hospital, building or a park.

13. A non-transitory machine readable medium storing machine executable instructions, the machine executable instructions comprising:
a geospatial shape generator that:
receives cell sector data for each of a plurality of cell sectors, wherein the cell sector data characterizes geocoordinates of each corresponding cell sector, a radius of communication of each cell sector and a beam width for each cell sector;
generates a geospatial shape for each of the plurality of cell sectors, wherein the geospatial shape for each respective cell sector characterizes geographical boundaries of a corresponding cell sector partition; and
a boundary coordinator that:
queries a geographic information system (GIS) for geographic coordinates for each public interest structure within boundaries of each respective geospatial shape; and
determines an emergency region for each public interest structure of a plurality of public interest structures identified by the GIS; and
a call route control that:
provides a list of the plurality of public interest structures;
receives a request to associate a given public interest structure of the list of public interest structures with an emergency incident; and
provides, in response to the request, a GIS reference characterizing a boundary of an emergency region that includes the given public interest structure to a network node of a public safety network that determines destination routing for emergency calls within the emergency region.

14. The medium of claim 13, wherein the request includes data identifying a particular answering group of a particular Public Answering Safety Point (PSAP) of a plurality of PSAPs.

15. The medium of claim 13, wherein a given geospatial shape is a two-dimensional (2D) shape.

16. The medium of claim 13, wherein the call route control provides data characterizing a uniform resource identifier (URI) of a particular emergency handling system for the emergency incident to the ECRF.

17. The medium of claim 13, wherein the boundary coordinator stores data characterizing the emergency region of each public interest structure in a database.

18. The medium of claim 13, wherein a given emergency region of a public interest structure of the plurality of public interest structures represents a boundary of a union of two or more geospatial shapes.

19. A method comprising:
receiving cell sector data for each of a plurality of cell sector, wherein the cell tower data characterizes geocoordinates of a cell tower for each of the plurality of cell sectors, a radius of communication of each cell sector and a beam width of each cell sector;
generating a geospatial shape for each of the plurality of cell sectors, wherein the geospatial shape for each respective cell sector characterizes geographical boundaries of a corresponding cell sector partition;
querying a geographic information system (GIS) for geographic coordinates for each public interest structure within boundaries of each respective geospatial shape;
determining an emergency region for each public interest structure of a plurality of public interest structures identified by the GIS;
receiving a request to associate a given public interest structure of a list of public interest structures with an emergency incident; and
providing, in response to the request, a GIS reference characterizing a boundary of an emergency region that includes the given public interest structure to a network node of a public safety network that determines destination routing for emergency calls within the emergency region.

20. The method of claim 19, wherein the particular emergency handling system is an answer group of a Public Answering Safety Point (PSAP) of a plurality of PSAPs.
